(19) United States
(12) Patent Application Publication
(10) Pub. No.: US 2014/0139844 A1
(43) Pub. Date: May 22, 2014

(54) OPTICAL SOURCE APPARATUS AND OPTICAL COHERENCE TOMOGRAPHY APPARATUS

(71) Applicant: CANON KABUSHIKI KAISHA, Tokyo (JP)

(72) Inventor: Makoto Oigawa, Kawasaki-shi (JP)

(73) Assignee: CANON KABUSHIKI KAISHA, Tokyo (JP)

(21) Appl. No.: 14/081,408

(22) Filed: Nov. 15, 2013

(30) Foreign Application Priority Data
Nov. 22, 2012 (JP) 2012-256208

(51) Int. Cl. H01S 3/107; G01B 9/02

(52) U.S. Cl. CPC H01S 3/1075; G01B 9/02091
USPC 356/479; 372/20

(57) ABSTRACT

The optical source apparatus includes a deflector that includes a first deflector and a second deflector which deflect the light emitted from the gain medium in a first direction and a second direction, respectively, and a wavelength selection element that has a first region and a second region which select light having any wavelength in a first wavelength range and a second wavelength range out of the light illuminating the wavelength selection element through the deflector, respectively, wherein the first region is structured so that the wavelengths of light selected along the first direction are different from each other, the second region is structured so that the wavelengths of light selected along the first direction are different from each other, and the second region is positioned in the second direction with respect to the first region.

### BACKGROUND OF THE INVENTION

1. Field of the Invention

The present invention relates to an optical source apparatus, and an optical coherence tomography apparatus provided with an optical source unit having the optical source apparatus.

2. Description of the Related Art

Conventionally, wavelength tuning optical sources have been known in applications for various measurement and communication. Among the optical sources, an external resonator type of optical source is known, particularly in which a diffraction orating or a wavelength selection filter is combined with a beam deflector. A polygon mirror and a mirror which is driven by a piezoelectric element are used as the deflector, but the mirrors have a mechanical actuator, and accordingly the wavelength tuning rate is determined by the working speed.

Then, in order to attain a higher wavelength tuning, a wavelength tuning optical source is proposed which has a mechanism of deflecting the beam by a deflector using an electro-optic (EO) effect (the deflector will be hereafter referred to as EO deflector). A common EO deflector is a device which has a shape of a prism, induces a change of a refractive index due to the EO effect by the application of voltage to the EO crystal, and varies an angle of an outgoing beam.

Japanese Patent Application Laid-Open No. 2003-198056 proposes a wavelength tuning type external resonator which uses this type of EO deflector, as in the following. This apparatus is structured, in a Littman type of external resonator, so as to vary a wavelength of light which is vertically incident on a mirror by applying voltage to the EO deflector which is arranged between a diffraction grating and the mirror, and consequently vary a lasing wavelength in the resonator. The external resonator is enabled so as to expand a wavelength tuning range and narrow a line width of a lasing wavelength, by increasing an angle to be deflected by the EO deflector.

In addition, the apparatus described in the specification of U.S. Pat. No. 7,065,108 employs a set of a wavelength selection filter and a curved mirror for a reflecting face in one side of a resonator, in a monolithic structure which is integrated on a semiconductor substrate, and is structured so as to select the wavelength with an EO deflector which is arranged between the set and a gain medium. The apparatus increases the deflection angle, expands a wavelength tuning range and narrows oscillation line width by giving the EO deflector a multistage structure.

As has been described in the above conventional example, when the apparatus deflects a beam by applying voltage to an EO crystal and varying a refractive index by the EO effect, it is desired to induce a large change of the refractive index in order to acquire a large deflection angle. A ratio of the change in the refractive index due to the EO effect is proportional to applied voltage, and is inversely proportional to the thickness of a film to which the voltage is applied. Accordingly it is desired to apply high voltage to the thin film. However, there exists a withstand voltage against a dielectric breakdown, and accordingly there is an opposite relation between thinning the film thickness and applying a high voltage. Accordingly there is limit in the greatest deflection angle which can be acquired with one EO deflector.

In addition, in the case of a structure in which the EO deflectors are produced in many stages in the same plane, an angle of light incident on a deflector in a subsequent stage changes because the beam is deflected by a deflector in a pre-stage. Accordingly, the apparatus having the structure has a problem that a large deflection angle is not acquired.

From these circumstances, a wavelength tuning optical source apparatus is desired which has a structure that decreases a deflection angle in a deflector while keeping a wavelength tuning range and oscillation line width.

### SUMMARY OF THE INVENTION

With respect to the above described problems, the present invention proposes an optical source apparatus which can expand a wavelength tuning range to a predetermined range even though a deflection angle in a deflector is decreased, and an optical coherence tomography apparatus provided with an optical source unit having the optical source apparatus.

The optical source apparatus according to the present invention includes: a resonator including a reflection mirror and a wavelength selection element for selecting light having a particular wavelength out of light illuminating the wavelength selection element, a gain medium and a deflector provided in an optical path of the resonator, the deflector changing a position at which the wavelength selection element is illuminated with light emitted from the gain medium, and emits light from the reflection mirror side, which has a wavelength selected by illuminating the wavelength selection element with the light emitted from the gain medium through the deflector, wherein the deflector includes a first deflector which deflects the light emitted from the gain medium in a first direction, and a second deflector which deflects the light emitted from the gain medium in a second direction that intersects with the first direction, wherein the wavelength selection element has a first region for selecting light having any wavelength in a first wavelength range out of light illuminating the wavelength selection element through the deflector, and a second region for selecting light having any wavelength in a second wavelength range that is different from the first wavelength range, out of the light illuminating the wavelength selection element through the deflector, wherein the first region is structured so that the wavelengths of light selected along the first direction are different from each other, wherein the second region is structured so that the wavelengths of light selected along the first direction are different from each other, and wherein the second region is positioned in the second direction with respect to the first region.

The optical coherence tomography apparatus of the present invention includes: an optical source unit having the optical source apparatus; a sample measuring unit which illuminates a sample with light from the optical source unit and transmits a reflected beam from the sample; a reference unit which illuminates a reference mirror with light from the optical source unit and transmits a reflected beam from the reference mirror; an interference unit which causes the reflected beam from the sample measuring unit and the reflected beam from the reference unit interfere with each other; a photodetection unit which detects interference beams from the interference unit; and an image processing unit which obtains a tomographic image of the sample based on light detected in the photodetection unit.

Further features of the present invention will become apparent from the following description of exemplary embodiments with reference to the attached drawings.

### BRIEF DESCRIPTION OF THE DRAWINGS

FIG. 1 illustrates structure example of an optical source apparatus according to an embodiment of the present invention.

FIG. 2 illustrates a structure of the optical source apparatus when FIG. 1 illustrating the embodiment of the present invention has been viewed from the upper side of the paper plane.

FIG. 3 is a view when a wavelength selection element in the embodiment of the present invention has been viewed from a direction perpendicular to an in-plane direction.

FIGS. 4A, 4B and 4C are views when the wavelength selection element of FIG. 3 in the embodiment of the present invention has been viewed from the upper side of the paper plane.

FIG. 5 illustrates a conventional wavelength tuning structure which uses one deflector.

FIGS. 6A, 6B and 6C illustrate a wavelength tuning structure in the optical source apparatus according to the present embodiment.

FIGS. 7A and 7B illustrate a structure example of the optical source apparatus in an Example of the present invention.

FIG. 8 illustrates a structure in a conventional example, in which one deflector has been used.

FIGS. 9A, 9B and 9C illustrate a wavelength tuning structure of the optical source apparatus the Example of the present invention.

FIG. 10 is a view for describing a method for sweeping a wavelength with the use of the optical source apparatus according to the Example of the present invention.

FIG. 11 illustrates a change of wavelength, which is obtained as a result of having used the optical source apparatus according to the Example of the present invention.

FIG. 12 illustrates a structure example of the SS-OCT which is an optical coherence tomography apparatus provided with an optical source unit having an optical source apparatus in the embodiment of the present invention.

### DESCRIPTION OF THE EMBODIMENTS

An optical source apparatus according to an embodiment of the present invention will be described below. The optical source apparatus according to the present embodiment includes, in an optical path of a resonator including a reflection mirror and a wavelength selection element that selects light having a particular wavelength out of light illuminating the wavelength selection element, a gain medium and a deflector that changes a position at which the wavelength selection element is illuminated with emitted from the gain medium; and emits light from the reflection mirror side, which has a wavelength selected by illuminating the wavelength selection element with the light emitted from the gain medium through the deflector. In addition, the deflector includes a first deflector which deflects the light emitted from the gain medium in a first direction, and a second, deflector which deflects the light emitted from the gain medium in a second direction that intersects with the first direction; and the wavelength selection element has a first region which selects light having any wavelength in a first wavelength range out of lint illuminating the wavelength selection element through the deflector, and a second region which selects light having any wavelength in a second wavelength range that is different from the first wavelength range out of the light illuminating the wavelength selection element through the deflector, wherein the first region is structured so that, the wavelengths of light selected along the first direction are different from each other, the second region is structured so that the wavelengths of light selected along the first direction are different from each other, and the second region is positioned in the second direction with respect to the first region.

Examples of the wavelength selection element of the optical source apparatus according to the present embodiment include a wavelength selection element in which diffraction gratings with an equal grating spacing are provided in the first, region and the second region, so as to have a gradient along the first direction. The sentence described here that the diffraction gratings are provided so as to have a gradient means that the diffraction gratings are provided so as to form an angle with respect to a plane formed by the first direction and the second direction. The examples of the wavelength selection element also include a wavelength, selection element that uses a wavelength, selection device such as a Fabry Perot (FP) filter, which selects light having a particular wavelength, and specifically includes a wavelength selection element in which the FP filters that select light having different wavelengths from each other are provided along the first direction.

The wavelength selection element in the present embodiment may be structured so that the wavelength of light to he selected along the first direction increases or decreases in the first region and the second region. The wavelength selection element may also be structured so chat the wavelengths of the light to be selected along the first direction continuously vary in the first region and the second region.

The present embodiment may also have a structure in which the light emitted from the gain medium is incident on the first deflector and then is incident on the second deflector, or also may have a structure in which the light is incident on the second deflector and then is incident on the first deflector.

In the present embodiment, the first wavelength range and the second wavelength range may be wavelength ranges different from each other, and the second wavelength range may include another wavelength range than the first wavelength range. The first wavelength range and the second wavelength range may also overlap each other. In addition, the wavelength selection element may also have a third region which selects light having any wavelength in a third wavelength range that is different from the first wavelength range and the second wavelength range, or may also have N pieces of regions in total (where N is integer of 4 or more).

The gain medium in the present embodiment is not limited in particular as long as the gain medium generates spontaneous emission light having a wavelength band width, and has an optical amplification function due to stimulated emission for incident, light which is incident on the gain medium. The operating wavelength, of the gain medium in the present embodiment desirably has a wavelength band width of approximately 50 nm to 200 nm, out of wavelengths from 700 nm to 2,000 nm. The light emitted from the gain medium can have a wavelength band particularly in a range of 780 nm to 900 nm, 980 nm to 1,100 nm, or 1,250 nm to 1,400 nm. Representative gain media include a semiconductor optical amplifier (which is hereinafter sometimes abbreviated as SOA). The gain media include a fiber to which a rare-earth element including erbium, ytterbium and neodymium is added, and an optical fiber or a substrate which contains a dye as an optical amplification material, in addition to the SOA. Materials which can be used as a material that constitutes an active layer of the SOA include a compound semiconductor that constitutes an active layer of a general semiconductor laser, and specifically include an InGaAs-based compound semiconductor, an InGaAsP-based compound semiconductor, a GaAsP-based compound semiconductor and an AlGaAs-based compound semiconductor. Representative central wavelengths of the gain which the SOA has can include 840 nm, 1,060 nm and 1,300 nm.

An OCT apparatus according to the present embodiment can be also described as in the following.

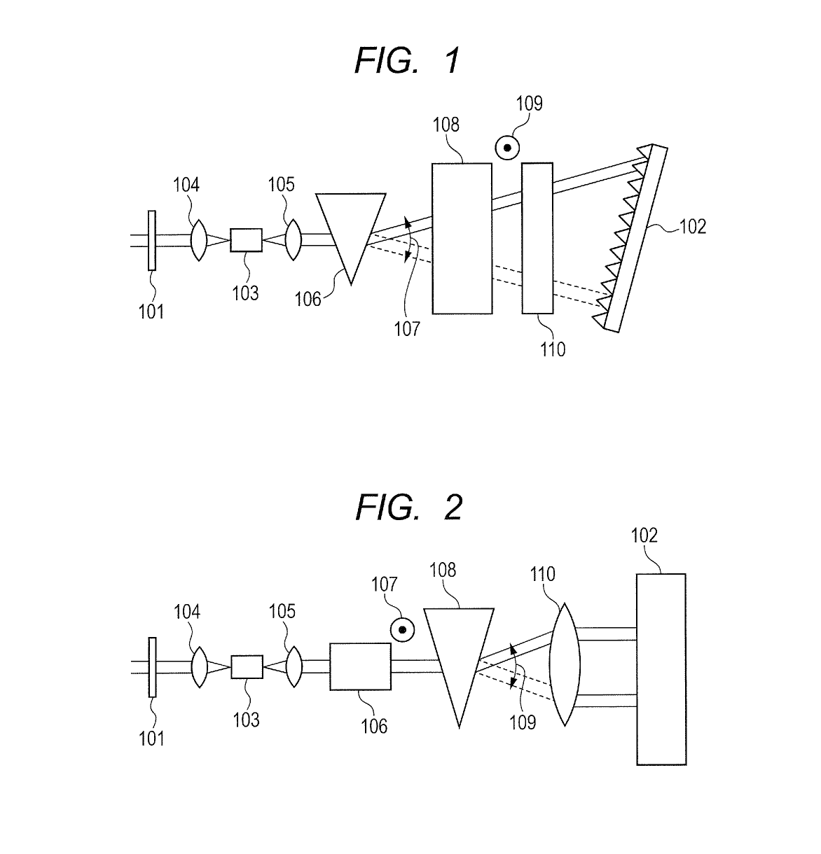

Structure examples of an optical source apparatus and a method for forming wavelength-swept light according to the embodiment of the present invention will be described below with reference to FIG. 14. The optical source apparatus of the present embodiment includes a gain medium and a deflector in a resonator which is structured by the reflection mirror and the wavelength selection element. Then, an external resonator type wavelength tuning optical source apparatus is structured that emits the light of which the wavelength has been varied by changing a place where the wavelength selection element is illuminated by light emitted from the gain medium through the deflector, from the side of the reflection mirror which constitutes the resonator. At this time, a means for deflecting the optical path in the resonator is structured in two stages. Specifically, as is illustrated in FIG. 1, an optical, resonator is formed of a half mirror for extraction (reflection mirror) 101 and a wavelength selection element 102, and a gain medium 103 is arranged in the optical resonator. A beam which has been emitted from the gain medium 103 and has a plurality of wavelengths is converted into parallel light by collimator lenses 104 and 105. The light which has been converted into the parallel light by the collimator lens 105 is deflected in a direction shown by a horizontal direction (first direction) 107 to the paper plane in FIG. 1, by a first deflector 106. After that, the light is deflected in a direction shown by a perpendicular direction (second direction) 109 to the paper plane, which intersects with the first direction, by a second deflector 108, and is led to the wavelength selection element 102 through a cylindrical lens 110 having power in the direction 109.

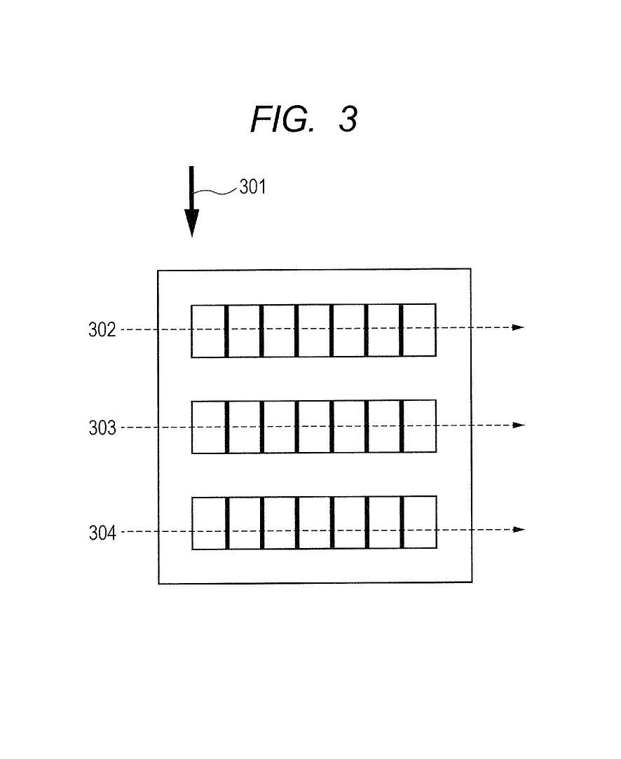

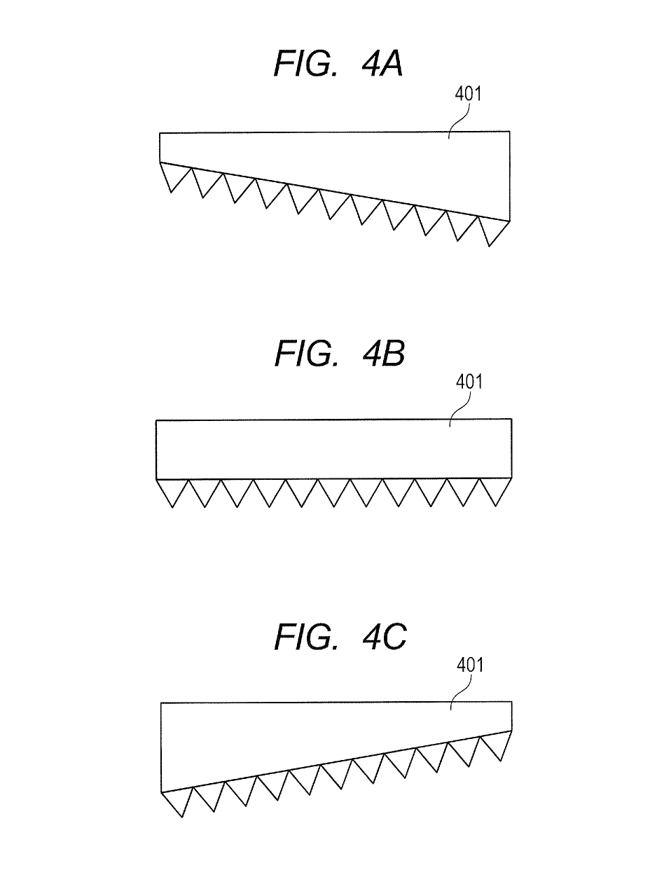

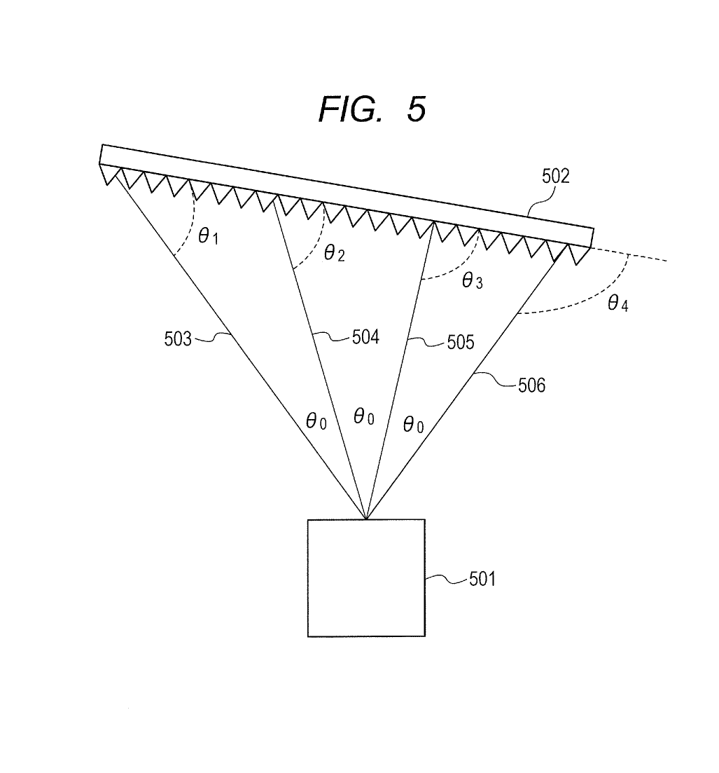

FIG. 2 illustrates a state when the optical source apparatus has been viewed from the direction 107 which forms a perpendicular relationship to that in the above described FIG. 1. In addition, FIG. 3 illustrates details of the wavelength selection element 102. This wavelength selection element 102 has reflection-type diffraction gratings with an equal pitch arranged at different angles from each other with respect to a substrate surface. FIG. 3 is a view when the wavelength selection element 102 has been viewed from the front face with respect to the substrate. FIG. 4A illustrates a cross-section view at a position 302 when the wavelength selection element 102 has been viewed from an upper side 301 of the wavelength selection element 102 in FIG. 4B illustrates a cross-section view at a position 303, and FIG. 4C illustrates a cross-section view at a position 304, respectively. Thus, the respective diffraction gratings have different angles from each other with respect to the substrate 401. The mechanism will be described below that such structure can decrease a deflection angle by one deflector while securing a wide wavelength tuning range.

FIG. 5 illustrates a conventional structure which can vary a wavelength using a combination of a beam deflector and a diffraction grating on the same flat surface. A deflector 501 deflects a beam in a range of an angle corresponding to an angle 3θ₀, and makes the beam incident on a reflection-type diffraction grating 502. At this time, the light having different wavelengths which depend on an angle formed by the diffraction crating and the incident light is strongly reflected to the same optical path. When an angle formed by the diffraction grating and a ray 503 is θ₁, the light having a wavelength λ₁ is reflected. When an angle formed by the diffraction grating and a ray 504 is θ₂, the light having a wavelength λ₂ is reflected. When an angle formed by the diffraction grating and a ray 505 is θ₃, the light having a wavelength λ₃ is reflected. When an angle formed by the diffraction grating and a ray 506 is θ₄, the light having a wavelength λ₄ is reflected.

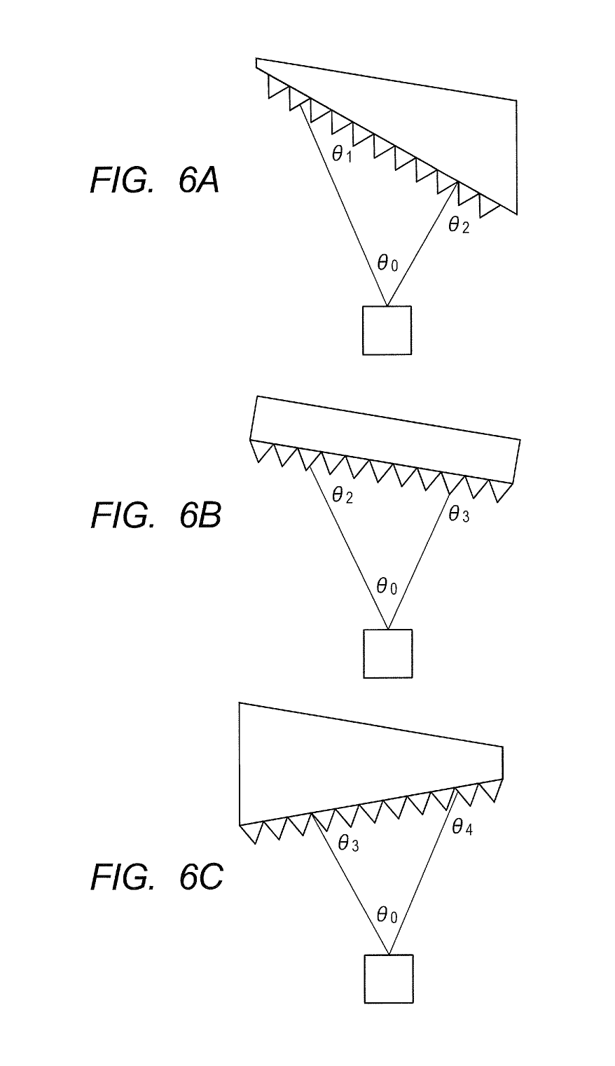

On the other hand, FIGS. 6A to 6C illustrate a state of wavelength selection according to the present invention. FIGS. 6A to 6C illustrate diffraction gratings which are arranged so as to tilt at different angles with respect to the substrate, in a similar way to the structure illustrated in FIGS. 4A to 4C. Even when a range of a deflection angle in the deflector is θ₀, the angle formed by the diffraction grating and the incident light can be varied from θ₁ to θ₂ in FIG. 6A, be varied from θ₂ to θ₃ in FIG. 6B, and be varied from θ₃ to θ₄ in FIG. 6C. In other words, the wavelength of reflected light can be varied from the wavelength λ₁ to the wavelength λ₄.

In this way, the structure illustrated in FIG. 1 according to the present invention deflects light also in a deflection direction by the second deflector 108, in addition to a deflection direction by the first deflector 106, and thereby can obtain an equivalent wavelength tuning range, in a smaller range of the deflection angle in the first deflector than that in the conventional structure. In other words, the structure can expand a wavelength tuning range of light to a predetermined range, by deflecting light which has been deflected by the first deflector 106 at a small deflection angle, by the second deflector 108, and making the resultant light incident on the wavelength selection element while varying an incident angle or an incident position of the light on the reflection-type diffraction gratings which have been arranged at different angles with respect to the substrate.

The combination of the direction 107 of the deflection angle by the first deflector and the direction 109 of the deflection angle by the second deflector is not limited to this combination, but may be any combination as long as places on the surface of the wavelength selection element 102 can be arbitrarily selected. Among the combinations, such a combination that the direction 107 and the direction 109 are perpendicular to each other can facilitate the control to be carried out when a lasing wavelength is selected.

An SS-OCT (Swept-Source Optical Coherence Tomography) apparatus will be described below which is an optical coherence tomography apparatus provided with an optical source unit that has an optical source apparatus according to the embodiment of the present invention.

The SS OCT apparatus of the present embodiment includes an optical source unit which illuminates a sample with light, a sample measuring unit which transmits a reflected beam from a sample, and a reference unit which illuminates a reference mirror with light and transmits a reflected beam from the reference mirror. The SS-OCT apparatus also includes an interference unit which makes the two reflected beams interfere with each other, a photodetection unit which detects the interfering beams that have been obtained by the interference unit, and an image processing unit which performs image processing (to obtain a tomographic image) based on the light that has been detected in the photodetection unit.

Specifically, as is illustrated in FIG. 12, light emitted from a wavelength tuning optical source 1201 which constitutes the optical source unit is divided through a coupler 1202, into sample light 1204 which is led to a sample 1203 and a reference light 1206 which is led to a fixed mirror 1205. After the light, has been divided, the sample light 1204 is led to the sample 1203 through a collimator lens 1207, a scanning mirror 1208 and an object lens 1209. Reflected beams with depth information of the sample 1203 return to the optical path, and return to the coupler 1202 again. On the other hand, the reference light 1206 passes through a collimator lens 1210 and an object lens 1211, then is reflected by the fixed mirror 1205, retraces the optical path, returns to the coupler 1202 again, is led to a photodiode 1212 together with the sample light, and generates an interference signal.

A calculation processor 1213 rearranges this interference signal based on an optical-source scanning signal, subjects the resultant signal to signal processing which centers on Fourier transformation, and thereby can acquire a depth-direction tomographic image. The SS-OCT apparatus can sweep wavelength at a high speed by using a wavelength-swept optical source according to the present invention, and enhances a speed for acquiring an OCT image.

Thereby, the SS-OCT apparatus can prevent the image from degrading due to the movement of the sample during measurement, and enhances an S/N ratio of the OCT image.

### EXAMPLE

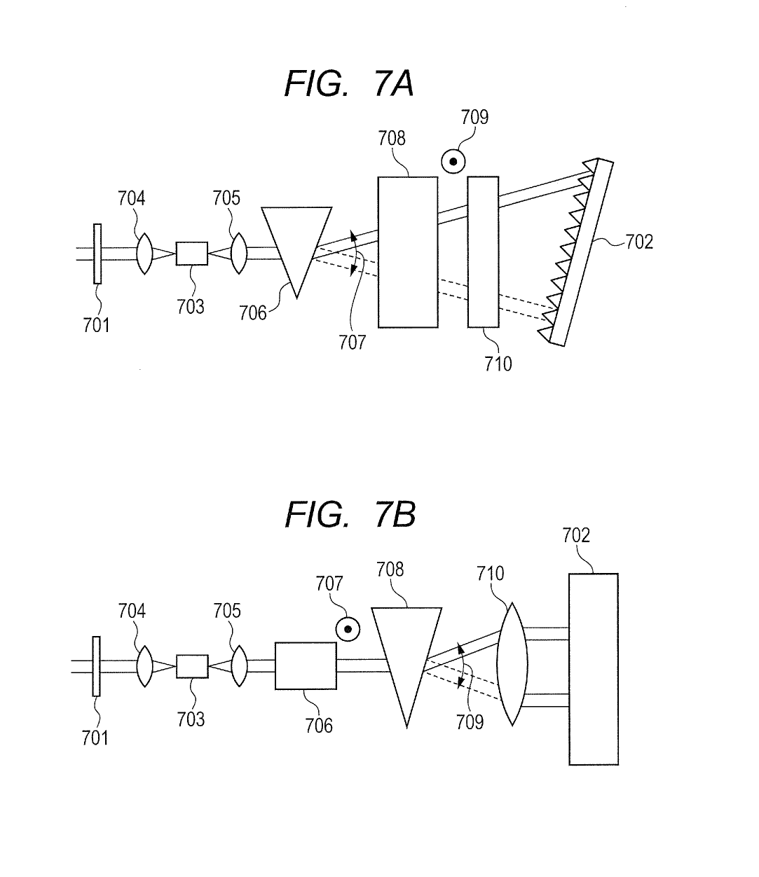

Structure examples of an optical source apparatus and a method for forming wavelength-swept light in an Example to which the present invention is applied will be described below with reference to FIGS. 7A and 7B. FIG. 7A and FIG. 7B are views when the optical source apparatus of the present example has been viewed from directions which are perpendicular to each other. In the optical source apparatus of the present example, an optical resonator is formed of a half mirror 701 for extraction and a reflection-type diffraction grating 702, as is illustrated in FIGS. 7A and 7B. In the optical resonator, a semiconductor optical amplifier (SOA) 703 is arranged which serves as a gain medium. The SOA 703 has a band of a gain from a wavelength of 800 nm to a wavelength of 880 nm, and the optical source of the present example can sweep the lasing wavelength of the optical source in this range. The light which is emitted from the SOA 703 and has a plurality of wavelengths is converted into parallel light by the collimator lenses 704 and 705. The light which has been converted into the parallel light by the collimator lens 705 is deflected in a direction 707 by a first EO deflector (deflector using electro-optical effect) 706. Next, the resultant light is deflected in a direction 709 by a second EO deflector (deflector using electro-optical effect) 708, and illuminates the reflection-type diffraction grating 702 through a cylindrical lens 710 having power in the direction 709.

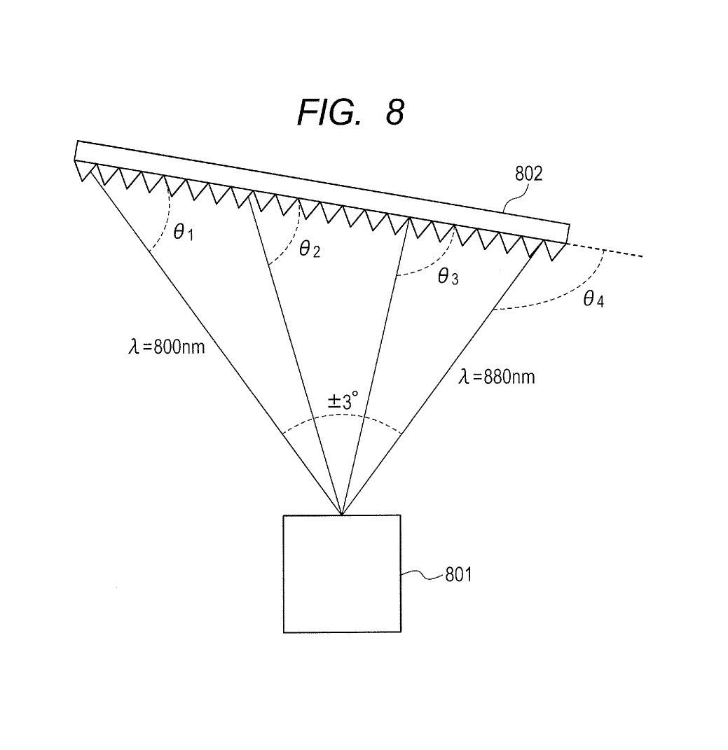

When a lasing wavelength is varied from a wavelength of 800 nm to a wavelength of 880 nm by combination of one reflection-type diffraction grating 802 and a deflector 801 as illustrated in FIG. 8, a diffraction grating having 1,800 lines/mm and a deflector having a deflection angle of ±3° are needed.

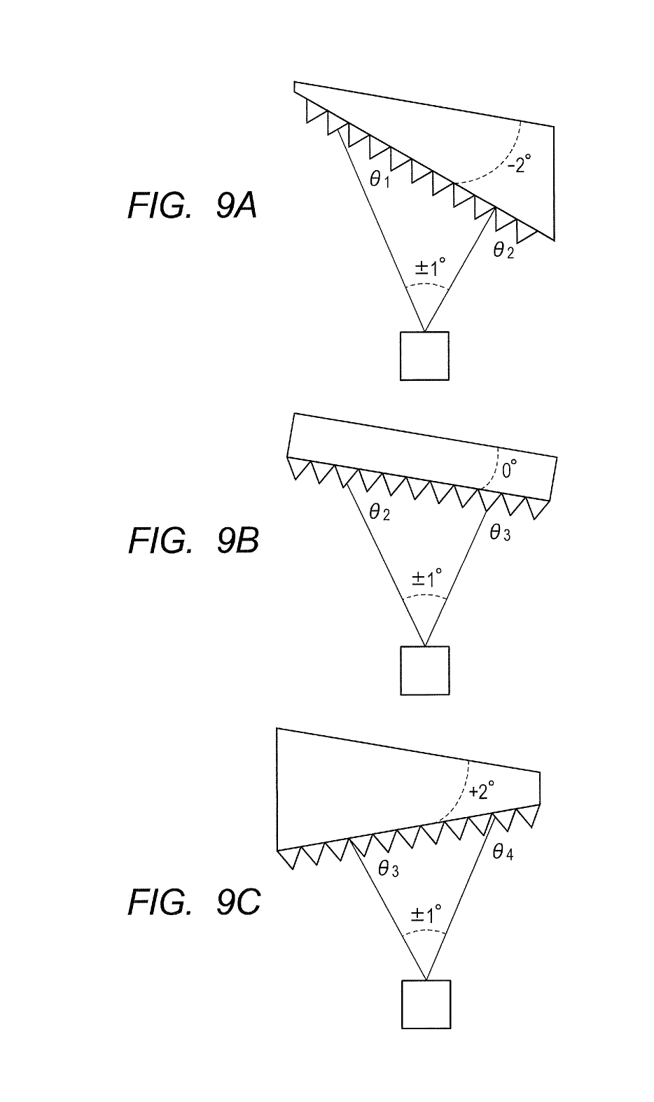

When the wavelength was varied by the structure of the present example, reflection -type diffraction gratings were produced so as to have a three-stage structure as illustrated in FIGS. 9A to 9C, and the diffraction gratings were structured by being arranged so as to tilt at −2°, 0° and +2°, respectively, with respect to the substrate. Thereby, a wavelength of light reflected from the diffraction grating varies from a wavelength of 800 nm to a wavelength of 880 nm for a deflection angle of +1° in the deflector.

Thus, when an incident angle on the surface of the reflection-type diffraction grating 702 is varied by a combination of the first deflector 706 and the second deflector 708, a deflection angle of one deflector for obtaining desired wavelength tuning range can be decreased.

Further, the above described first deflector and the above described second deflector can be formed by a combination of the EO deflector and a polygon mirror. In addition, the above described first deflector and the above described second deflector can be formed by a combination of the EO deflector and an MEMS mirror.

According to above description, when a plurality of EO deflectors is used, a deflection angle larger in total can be obtained than the case where a single EO deflector is used. In addition, when the diffraction grating is used which has a structure of more multiple stages than a three-stage structure, a deflection angle needed for each deflector can be decreased.

A method for sweeping a lasing wavelength of the optical source in one direction along with time by using the above described optical source according to the present example will be described below.

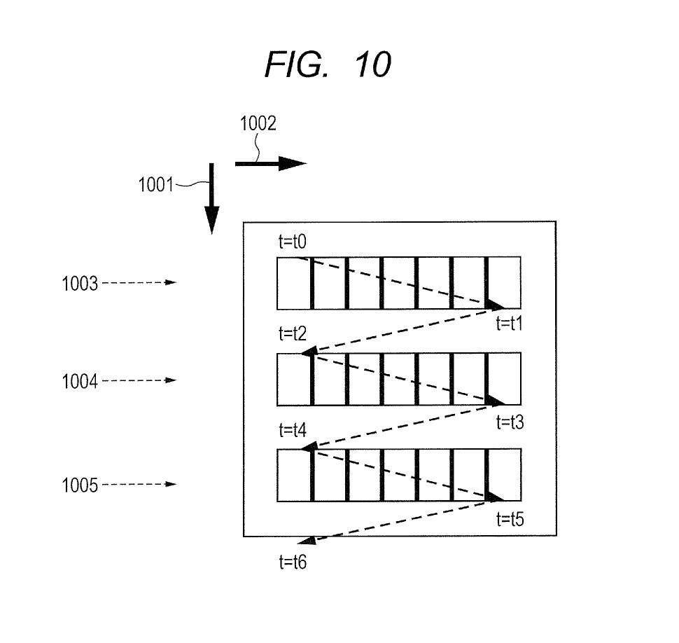

FIG. 10 illustrates a view when the wavelength selection element 702 is viewed from a front face which is illuminated with light. A cross-section view at a position 1003 when viewed from a direction 1001 in FIG. 10 corresponds to FIG. 9A, a cross-section view at a position 1004 corresponds to FIG. 9B, and a cross-section view at a position 1005 corresponds to FIG. 9C, respectively Light is moved in a direction 1002 in a scanning manner by the first deflector 706, and light is moved in the direction 1001 in a scanning manner by the second deflector 708.

When the ray is reciprocatingly moved in a scanning manner by the first deflector 706, the ray is moved on the diffraction grating at the position 1003 in a scanning manner between time t=t0 and t=t1, and the second deflector 708 is driven so that the ray is moved on the diffraction grating at the position 1004 in a scanning manner between time t=t2 and t=t3. After the time t=t3, a beam deflection by the deflector is similarly rebeated so that the scanning of the ray becomes raster scanning, until, the time reaches t=t6.

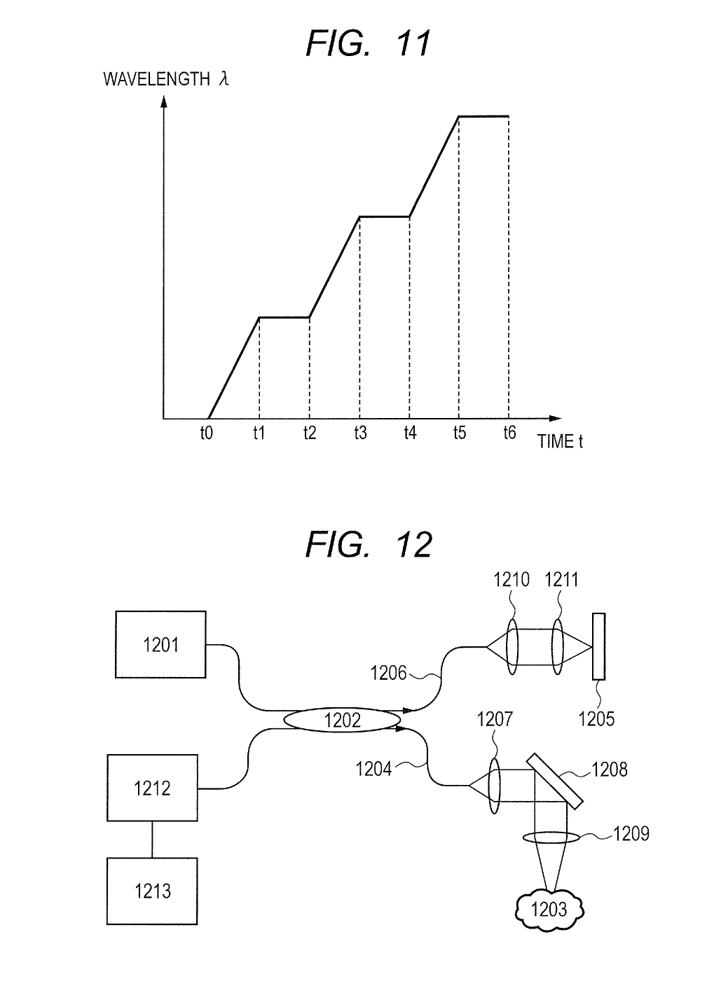

Thus, the lasing wavelength is sequentially varied along with time. This state is illustrated in FIG. 11.

The present invention can achieve an optical source apparatus which can expand a wavelength tuning range to a predetermined range even though a deflection angle in a deflector is decreased, and an optical coherence tomography apparatus provided with an optical source unit having the optical source apparatus.

While the present invention has been described with reference to exemplary embodiments, it is to be understood that the invention is not limited to the disclosed exemplary embodiments. The scope of the following claims is to be accorded the broadest interpretation so as to encompass all such mod fi cations and equivalent structures and functions.

This application claims the benefit of Japanese Patent Application No. 2012-256208, filed, Nov. 22, 2012, which is hereby incorporated by reference herein in its entirety.

What is claimed is:

1. An optical source apparatus which comprises:
a resonator including a reflection mirror and a wavelength selection element arranged to select light having a particular wavelength out of light illuminating the wavelength selection element,
a gain medium and a deflector provided in an optical path of the resonator, the deflector changing a position at which the wavelength selection element is illuminated with light emitted from the gain medium, and
which emits light from the reflection mirror side which has a wavelength selected by illuminating the wavelength selection element with the light emitted from the gain medium through the deflector,
wherein the deflector includes a first deflector which deflects the light emitted from the gain medium in a first direction, and a second deflector which deflects the light emitted from the gain medium in a second direction that intersects with the first direction,
wherein the wavelength selection element has
a first region arranged to select, light having any wavelength in a first wavelength range out of light illuminating the wavelength selection element through the deflector, and
a second region arranged to select light having any wavelength in a second wavelength range that is different from the first wavelength range, out of the light illuminating the wavelength selection element through the deflector,
wherein the first region is arranged so that the wavelengths of light selected along the first direction are different from each other,
wherein the second region is arranged so that the wavelengths of light selected along the first direction are different from each other, and
wherein the second region is positioned in the second direction with respect to the first region.

2. The optical source apparatus according to claim 1, wherein light to be deflected in the second direction is deflected perpendicularly to light to be deflected, in the first direction.

3. The optical source apparatus according claim 1, wherein the first deflector and the second deflector include a combination of deflectors using an electro optical effect.

4. The optical source apparatus according to claim 1, wherein the first deflector and the second deflector include a combination of a deflector using an electro optical effect and a polygon mirror.

5. The optical source apparatus according to claim 1, wherein the first deflector and the second deflector include a combination of a deflector using an electro optical effect and a MEMS mirror.

6. The optical source apparatus according to claim 1, which sequentially sweeps a lasing wavelength of the optical source apparatus along with time by performing raster scanning to the wavelength selection element.

7. An optical coherence tomography apparatus comprising:
an optical source unit having the optical source apparatus according to the claim 1;
a sample measuring unit arranged to illuminate a sample with light from the optical source unit and transmit a reflected beam from the sample;
a reference unit arranged to illuminate a reference mirror with light from the optical source unit and transmit a reflected beam from the reference mirror;
an interference unit arranged to cause the reflected beam from the sample measuring unit and the reflected beam from the reference unit to interfere with each other;
a photodetection unit arranged to detect interfering beams from the interference unit; and
an image processing unit arranged to obtain a tomographic image of the sample based on light detected in the photodetection unit.
